(19) United States
(12) Patent Application Publication
(10) Pub. No.: US 2011/0299073 A1
(43) Pub. Date: Dec. 8, 2011

(54) SPECTROMETRIC INSTRUMENT

(75) Inventor: Kazunori SAKURAI, Chino (JP)

(73) Assignee: SEIKO EPSON CORPORATION, Tokyo (JP)

(21) Appl. No.: 13/087,631

(22) Filed: Apr. 15, 2011

(30) Foreign Application Priority Data
Jun. 2, 2010 (JP) 2010-126653

(51) Int. Cl. G01J 3/427

(52) U.S. Cl. 356/319

(57) ABSTRACT

A colorimetric instrument includes a power control section adapted to vary the power to be applied to the light source between the wavelengths in accordance with at least one of spectral characteristics of the light source, spectral characteristics of the measurement optical system, and light receiving sensitivity characteristics of the light receiving section.

### BACKGROUND

1. Technical Field

The present invention relates to a spectrometric instrument.

2. Related Art

As an example of a spectrometric instrument, there can be cited a colorimeter, and further, as another example thereof, there can be cited a spectroscopic analyzer for measuring the spectral reflectivity (the spectral transmission or the spectral absorption factor) of light. Further, the spectrometric instrument also includes a spectroscopic camera.

As a method of representing object colors, there is widely used a representation method using the XYZ color system set by the International Commission on Illumination (CIE). As a light source for colorimetric measurement, a standard light source (including, e.g., a standard illuminant and an auxiliary illuminant set by CIE) is defined in the standard (the standard regarding measurement of object colors) set by, for example, ISO/CIE, or JIS. The standard light source denotes, for example, an artificial light source set by CIE for realizing standard light defined for colorimetric measurement.

As the standard light source, for example, “A” (A light source) of the incandescent color or “D65” (D65 light source) of the daylight color is standardized as the standard illuminant. As the light sources of the colorimetric instrument of the related art, there are mostly used tungsten lamps capable of reproducing the A light source. However, because of its large power consumption, it is required for the portable colorimetric instrument using a battery to mount a large battery. Therefore, the shape and the weight of the colorimetric instrument increase, which makes it difficult to apply such a light source to a small-sized device superior in portability.

Further, as the light source for reproducing the daylight color, the D65 light source is defined. It should be noted that in the actual colorimetric measurement, the fluorescent lamp adjusted to have the dispersion spectrum similar to that of the D65 light source is generally used. It should be noted that the dispersion spectrum has several bright lines in the visible range, and further, the miniaturization of the fluorescent lamp has limitations.

JP-A-2003-8911 (Document 1) describes an example in which a white LED is used as the light source for the colorimetric measurement in an image reading device instead of a tungsten lamp or a fluorescent lamp. In Document 1, the white light is generated using a plurality of LEDs and a fluorescent plate, and further, the variation in emission wavelength is reduced by using the LEDs in the same shade rank.

The white LEDs have strong characteristics of small-sized, low power consumption, and long life, on the one hand, but also have a discontinuous and sharp peak in a part of the spectral radiance (spectral radiant intensity) distribution, on the other hand. Therefore, in the case in which the reflectance spectrum of the measurement object is measured, the measurement error becomes large around the peak wavelength. According to the technology described in Document 1 fails to solve the problem described above.

Further, also in the case in which the white LEDs are used for a spectroscopic analyzer, a spectroscopic camera, the presence of the discontinuous peak described above contributes to the degradation of the measurement accuracy.

### SUMMARY

An advantage of at least one aspect of the invention is to achieve a lower power consumption or a longer life of the light source while preventing the degradation in the measurement accuracy of the colorimetric instrument, for example. Another advantage of at least one aspect of the invention is to improve in the measurement accuracy of the spectroscopic analyzer can be improved, for example.

1. According to an aspect of the invention, there is provided a spectrometric instrument including a light source, alight source drive section including a power control section adapted to control drive power of the light source, a measurement optical system including a spectroscopic section adapted to disperse light into wavelengths, a light receiving section adapted to receive one of a reflected light beam and a transmitted light beam from a sample as a measurement object passing through the measurement optical system, and converting the light beam received into an electrical signal, and a measurement section adapted to measure a light receiving intensity corresponding to each of the wavelengths of the light beam based on the electrical signal obtained from the light receiving section, wherein the power control section varies the power to be applied to the light source between the wavelengths in accordance with at least one of spectral characteristics of the light source, spectral characteristics of the measurement optical system, and light receiving sensitivity characteristics of the light receiving section.

According to this aspect of the invention, the radiance (radiant intensity) of the light source can be varied between the wavelengths. For example, in the colorimetric instrument, it is possible to make the spectral radiance distribution (having a discontinuous and sharp peak, in reality) of the white LED light source or the like approximate to the relative spectral intensity distribution of the standard light source defined in CIE. Therefore, the white LED light source can be used as the standard light source. The light source using the solid-state light emitting element such as a white LED light source is suitable to be miniaturized, easy to provide higher brightness, and has characteristics of low power consumption and long life, and therefore, it is possible to achieve reduction of power consumption or improvement of product life of the light source while preventing degradation of measurement accuracy of the colorimetric instrument (i.e., while preventing the peak in the spectral radiance distribution).

Further, if this aspect is applied to the light source of the spectroscopic analyzer, for example, by preventing the difference (variation) in emission intensity between the wavelengths of the light source, the measurement accuracy of the spectroscopic analyzer can be improved. Further, the variation in spectral sensitivity between the wavelengths of the light receiving section can also be compensated by correcting the spectral radiance of the light source. Further, it is also possible to prevent the variation in the intensity of the output of the light receiving section (the detector such as a photodiode) between the wavelengths caused by, for example, the spectral characteristics of the measurement optical system such as illumination, an optical filter, or a lens, and the spectral sensitivity of the light receiving section from varying in accordance with the wavelength (i.e., to realize flat intensity distribution characteristics with respect to the wavelength). Therefore, it is possible to prevent the measurement accuracy of the spectroscopic analyzer from varying depending on the wavelength.

2. According to another aspect of the invention, in the spectrometric instrument of the above aspect of the invention, the spectrometric instrument is a colorimetric instrument adapted to measure a color of the sample, the light source has spectral radiance characteristics having a discontinuous peak in apart of a wavelength band, and the power control section controls the power to be applied to the light source so that a variation in the spectral radiance of the light source at the discontinuous peak is reduced.

According to this aspect of the invention, it is possible to change the spectral radiance characteristics of the light source having the discontinuous peak to the characteristics with the peak reduced. If the radiance distribution of the light source shows the discontinuous peak, when, for example, the actual emission wavelength is slightly shifted from the ideal emission wavelength, the radiance varies dramatically to thereby cause the measurement error. If the peak is reduced, it becomes difficult to cause a significant measurement error. Therefore, the error in the colorimetric measurement and the error in the spectroscopic analysis can be reduced.

3. According to still another aspect of the invention, in the spectrometric instrument of the above aspect of the invention, the spectrometric instrument is a colorimetric instrument adapted to measure a color of the sample, and the power control section controls the power to be applied to the light source so that a spectral radiance distribution of the light source approximates to a relative spectral intensity distribution of a standard light source defined by a standard related to measurement of an object color.

According to this aspect of the invention, it becomes possible to use a variety of light sources as a pseudo standard light source.

In other words, it is possible to use, for example, the white LED light source (the solid-state light emitting element light source) as the light source of the colorimetric instrument, and to adjust the spectral radiance characteristics of the light source so as to approximate to (including “conform with”) the relative spectral intensity characteristics of the standard light source (e.g., the standard illuminant or the auxiliary illuminant) defined by CIE, JIS, or the like. Therefore, it is possible to realize reduction of power consumption and improvement of product life of the light source without degrading the accuracy of the colorimetric measurement.

4. According to yet another aspect of the invention, in the spectrometric instrument of the above aspect of the invention, the spectrometric instrument is a spectroscopic analyzer adapted to analyze the sample, and the power control section controls the power to be applied to the light source so as to reduce a difference in radiance of the light source between the wavelengths in a measurement wavelength band.

According to this aspect of the invention, by preventing the difference (variation) in emission intensity between the wavelengths of the light source of the spectroscopic analyzer, the measurement accuracy of the spectroscopic analyzer can be improved.

5. According to still yet another aspect of the invention, in the spectrometric instrument of the above aspect of the invention, the power control section controls the power to be applied to the light source so as to reduce a difference in radiance of the light source between the wavelengths, and to reduce a difference in light receiving sensitivity of the light receiving section between the wavelengths.

According to this aspect of the invention, the variation in spectral sensitivity between the wavelengths of the light receiving section can be compensated by correcting the spectral radiance of the light source. Therefore, the measurement accuracy of the spectroscopic analyzer can further be improved.

6. According to further another aspect of the invention, in the spectrometric instrument of the above aspect of the invention, the power control section controls the power to be applied to the light source so as to reduce a variation in the spectral output of the light receiving section between the wavelengths in the measurement wavelength band due to spectral characteristics obtained by synthesizing radiance characteristics of the light source, spectral characteristics of the measurement optical system in each of the wavelengths, and spectral sensitivity characteristics of the light receiving section.

According to this aspect of the invention, it is possible to reduce the variation (the variation in the intensity between the wavelengths) of the light receiving section due to the spectral characteristics obtained by synthesizing the radiance characteristics of the light source, the spectral characteristics of the measurement optical system in each of the wavelengths, and the spectral sensitivity characteristics of the light receiving section. For example, it is possible to prevent the variation in the intensity of the output of the light receiving section (the detector such as a photodiode) between the wavelengths caused by, for example, the spectral characteristics of the measurement optical system such as illumination, an optical filter, or a lens, and the spectral sensitivity of the light receiving section from varying in accordance with the wavelength (i.e., to realize flat intensity distribution characteristics with respect to the wavelength). Therefore, it is possible to prevent the measurement accuracy of the spectroscopic analyzer from varying depending on the wavelength, and thus the measurement accuracy of the spectroscopic analyzer is further improved.

7. According to still further another aspect of the invention, in the spectrometric instrument of the above aspect of the invention, the light source is one of an incandescent lamp, a fluorescent lamp, a discharge tube, and a solid-state light emitting element.

In any one of the aspects of the invention described above, the radiance distribution of the light source can freely be adjusted, and therefore, it becomes possible to perform the spectrometric measurement with high accuracy using a variety of light sources.

8. According to yet further another aspect of the invention, in the spectrometric instrument of the above aspect of the invention, the spectroscopic section is one of an etalon filter, a variable wavelength filter, and a diffraction grating.

As the spectroscopic section, there can be used a transmissive spectroscopic element (e.g., an etalon filter and a variable wavelength filter), and further, a reflective spectroscopic element (e.g., a diffraction grating) can also be used. For example, if the variable-gap etalon filter is used as the spectroscopic element, although it is possible to obtain a simple, small-sized, and low-price spectroscopic section, the spectral accuracy is inevitably degraded compared to expensive spectroscopic elements. Although it is also possible that the measurement accuracy is further degraded depending on the radiance characteristics of the light source, according to any one of the aspects described above, since the degradation of the measurement accuracy due to the spectral radiance characteristics of the light source is sufficiently reduced, even if the variable-gap etalon filter or the like is used, a workable spectrometric instrument can be realized.

### BRIEF DESCRIPTION OF THE DRAWINGS

The invention will be described with reference to the accompanying drawings, wherein like numbers reference like elements.

FIG. 1 is a diagram showing an example of a configuration of a spectrometric instrument according to the invention.

FIG. 2 is a diagram showing an example of a specific configuration of the spectrometric instrument.

FIGS. 3A and 3B are diagrams showing a configuration example and an example of the characteristics of a variable-gap etalon filter, respectively.

FIGS. 4A through 4C are diagrams showing a configuration example of the colorimetric instrument and a measurement result of a color (red) of a sample.

FIGS. 5A through 5C are cross-sectional views of a device showing a configuration example of a white LED.

FIGS. 6A and 6B are diagrams showing a characteristic example of a white LED.

FIGS. 7A through 7D are diagrams for explaining an example of power control of a light source for using the white LED as a standard A light source (a standard illuminant A).

FIG. 8 is a diagram showing examples of reflectance spectra of a healthy leaf and an unhealthy leaf, respectively.

FIGS. 9A through 9C are diagrams showing an example of power control for setting the spectral radiance of the light source to approximately constant in a predetermined wavelength range.

FIGS. 10A through 10D are diagrams for explaining an example of controlling the radiance characteristics of the light source taking the spectral characteristics of the light receiving section (detector) into consideration.

### DESCRIPTION OF EXEMPLARY EMBODIMENTS

Hereinafter, some preferred embodiments of the invention will be described in detail. It should be noted that the present embodiment explained below does not unreasonably limit the content of the invention as set forth in the appended claims, and all of the constituents set forth in the present embodiments are not necessarily essential as means of the invention for solving the problems.

### First Embodiment

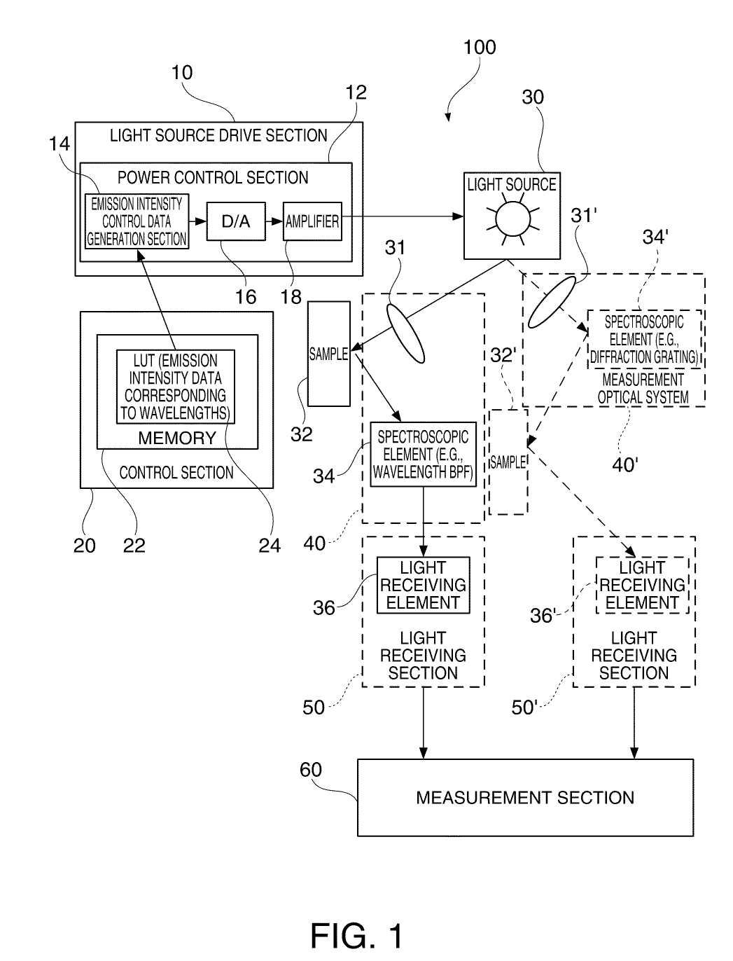

FIG. 1 is a diagram showing an example of a configuration of a spectrometric instrument according to the invention. The spectrometric instrument 100 has a light source drive section 10, a control section 20 for controlling the emission brightness (emission intensity) of the light source in correspondence with the wavelength, a light source 30, a measurement optical system 40 or 40′, a light receiving section 50, and a measurement section 60.

Specifically, the control section 20 has a memory (a control memory) 22 storing, for example, a look-up table (LUT) 24 having the emission intensity data (the control data) corresponding to the wavelength as a table.

Further, the light source drive section 10 has a emission intensity control data generation section 14 for generating the emission intensity control data based on the control data retrieved from the control memory 22, a D/A converter 16 for generating an emission intensity control signal corresponding to the emission intensity control data, and an amplifier 18 for amplifying the D/A conversion output.

Further, as the light source 30, either one of the light sources (solid-state light emitting element light sources) respectively using solid-state light emitting elements such as an incandescent bulb, a fluorescent lamp, a discharge tube, and an LED. In the present embodiment, the radiance distribution of the light source can freely be adjusted, and therefore, a variety of light sources can be used. It should be noted that the solid-state light emitting element light source can be miniaturized and has characteristics of long life and low power consumption, and is therefore suitable for putting the small-sized (e.g., small enough to be portable) spectrometric instrument into practice.

Further, either one of the measurement optical systems 40 and 40′ can arbitrarily be adopted. The measurement optical system 40 (40′) can be provided with, for example, a lens 31 (31′), and a spectroscopic section (a spectroscopic element such as a wavelength band-pass filter or a diffraction grating) 34 (34′). In the measurement optical system 40, there is adopted a configuration of disposing the spectroscopic section 34 (here, the wavelength band-pass filter) in the posterior stage of the sample 32 as the object of spectroscopic measurement. In the measurement optical system 40′, there is adopted a configuration of disposing the spectroscopic section 34′ (here, a reflective spectroscopic element such as a diffraction grating) in the anterior stage of the sample 32 as the object of spectroscopic measurement.

Further, the measurement optical systems 40, 40′ are each a measurement optical system corresponding to the configuration of receiving the reflected light from the sample 32 as the object of spectroscopic measurement using the light receiving section 50. It should be noted that the measurement optical systems are not limited thereto, but it is also possible to modify the configuration so as to correspond to the configuration of receiving the transmitted light from the sample 32 using the light receiving section 50.

Further, as the spectroscopic section 34 (34′), there can be used an etalon filter, a variable wavelength filter (e.g., a rotating band-pass filter having a plurality of band-pass filters with respective transmission bands different from each other incorporated in a rotatable disk), a diffraction grating, and so on. As the spectroscopic section 34, there can be used a transmissive spectroscopic element (e.g., an etalon filter and a variable wavelength filter), and further, a reflective spectroscopic element (e.g., a diffraction grating) can also be used. The configuration and so on of the etalon filter will be described later.

Further, the light receiving section 50 is a detector having a photoelectric conversion function, and can specifically be provided with a light receiving element 36 (or 36′) such as a photodiode (PD). Further, the measurement section 60 performs a predetermined process (e.g., a correction process of the signal intensity taking the spectral characteristics of the optical system used for colorimetric measurement) based on the light reception signal output from the light receiving section 50 to thereby generate the measurement signal representing the spectroscopic measurement result.

According to the spectrometric instrument having the configuration shown in FIG. 1, it is possible to vary the radiance (the radiant intensity) of the light source 30 in accordance with the wavelength. For example, in the colorimetric instrument, it is possible to make the spectral radiance distribution (having a discontinuous and sharp peak, in reality) of the white LED light source or the like approximate to the relative spectral intensity distribution of the standard light source defined in CIE. Therefore, the white LED light source can be used as the standard light source. The light source using the solid-state light emitting element such as a white LED light source is suitable to be miniaturized, easy to provide higher brightness, and has characteristics of low power consumption and long life, and therefore, it is possible to achieve reduction of power consumption or improvement of product life of the light source while preventing degradation of measurement accuracy of the colorimetric instrument (i.e., while preventing the peak in the spectral radiance distribution).

Further, in the spectroscopic analyzer, for example, by preventing the difference (variation) in emission intensity between the wavelengths of the light source 30, the measurement accuracy of the spectroscopic analyzer can be improved. Further, the variation in spectral sensitivity between the wavelengths of the light receiving section 50 (the light receiving element 36 (36′)) can also be compensated by correcting the spectral radiance of the light source 30. Further, as an application example, it is also possible to prevent the variation in the intensity of the output of the light receiving section (the detector such as a photodiode) between the wavelengths caused by, for example, the spectral characteristics of the measurement optical system such as illumination, an optical filter, or a lens, and the spectral sensitivity of the light receiving section from varying in accordance with the wavelength (i.e., to realize flat intensity distribution characteristics with respect to the wavelength). Therefore, it is possible to prevent the measurement accuracy of the spectroscopic analyzer from varying depending on the wavelength.

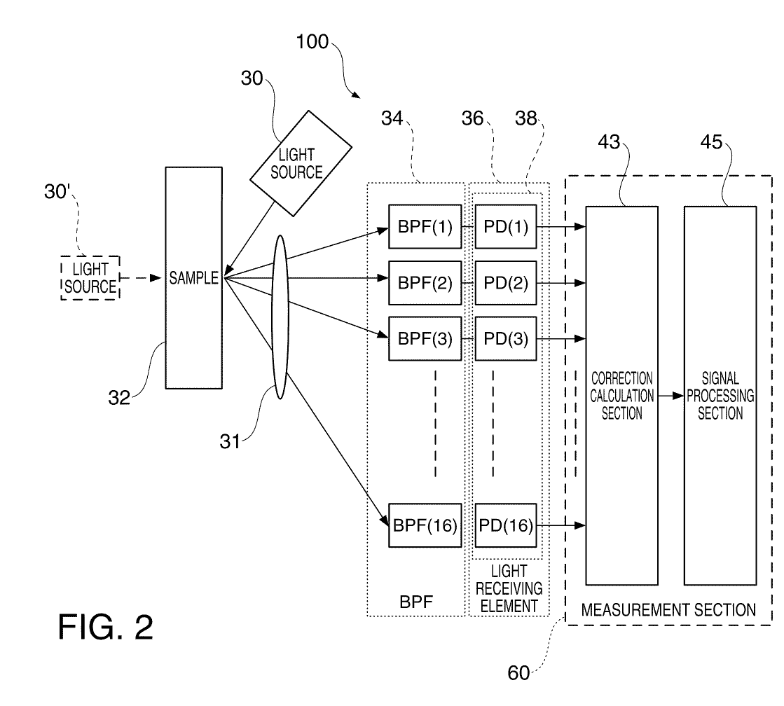

FIG. 2 is a diagram showing an example of a specific configuration of the spectrometric instrument. It should be noted that the light source 30 is used in the case of using the reflected light from the sample 32, and the light source 30′ is used in the case of using the transmitted light from the sample 32.

The reflected light or the transmitted light from the sample 32 passes through the lens 31, and is then dispersed by the spectroscopic section 34. The spectroscopic section 34 is substantively provided with band-pass filters BPF(1) through BPF (16) with respective transmission wavelength bands different from each other (it is possible to arrange 16 band-pass filters in parallel to each other or to realize 16 transmission wavelength bands with one filter using a variable-gap etalon filter or the like). The dispersed light output from each of the band-pass filters BPF(1) through BPF(16) is received by corresponding one of photodiodes PD(1) through PD(16) included in a light receiving section 38 to be converted into an electrical signal.

The measurement section 60 has a correction calculation section 43 and a signal processing section 45. The correction calculation section 43 performs (but is not limited to performing), for example, signal processing for compensating the spectral characteristics of the measurement optical system and the light receiving section. Further, the signal processing section 45 obtains the relative spectral intensity value corresponding to the wavelength by calculation based on the corrected signal.

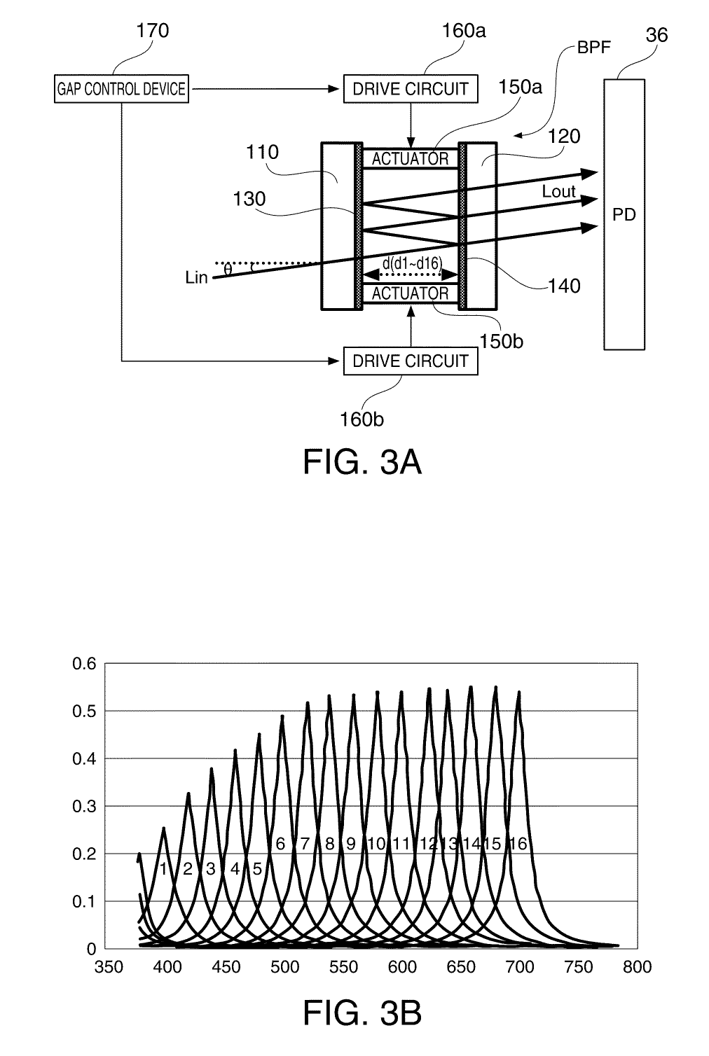

FIGS. 3A and 3B are diagrams showing a configuration example and an example of the characteristics of the variable-gap etalon filter, respectively. As shown in FIG. 3A, the variable-gap etalon filter has a first substrate 110 and a second substrate 120 disposed so as to be opposed to each other, a first reflecting film 130 disposed on a principal surface (the obverse surface) of the first substrate 110, a second reflecting film 140 disposed on a principal surface (the obverse surface) of the second substrate 120, and a first actuator (e.g., a piezoelectric element) 150a and a second actuator 150b sandwiched by the substrates and adapted to control the gap (the distance) between the substrates.

The first actuator 150a and the second actuator 150b are respectively driven by a first drive circuit 160a and a second drive circuit 160b. Further, the operations of the first drive circuit 160a and the second drive circuit 160b are controlled by a gap control circuit 170.

The light Lin entering from the outside at a predetermined angle θ passes through the reflecting film 130 while being hardly scattered. The reflection of the light is repeated between the reflecting film 130 provided to the first substrate 110 and the reflecting film 140 provided to the second substrate 120 to thereby cause the interference of light, and thus a part of the incident light passes through the second reflecting film on the second substrate 120 to reach the light receiving element 36 (the photodiodes PD). The wavelength of the light beams reinforcing each other depends on the gap between the first substrate 110 and the second substrate 120. Therefore, it is possible to vary the wavelength band of the light to be transmitted by variably controlling the gap.

FIG. 3B shows the spectral characteristics (the spectral intensity in each of the 16 wavelength bands each having a width of 20 nm) of the variable-gap etalon filter. By using the variable-gap etalon filter as the spectroscopic section 34, a plurality of transmission wavelength bands can be realized by a single filter. Therefore, there is provided an advantage that a simple, small-sized, and low-price spectroscopic section can be obtained.

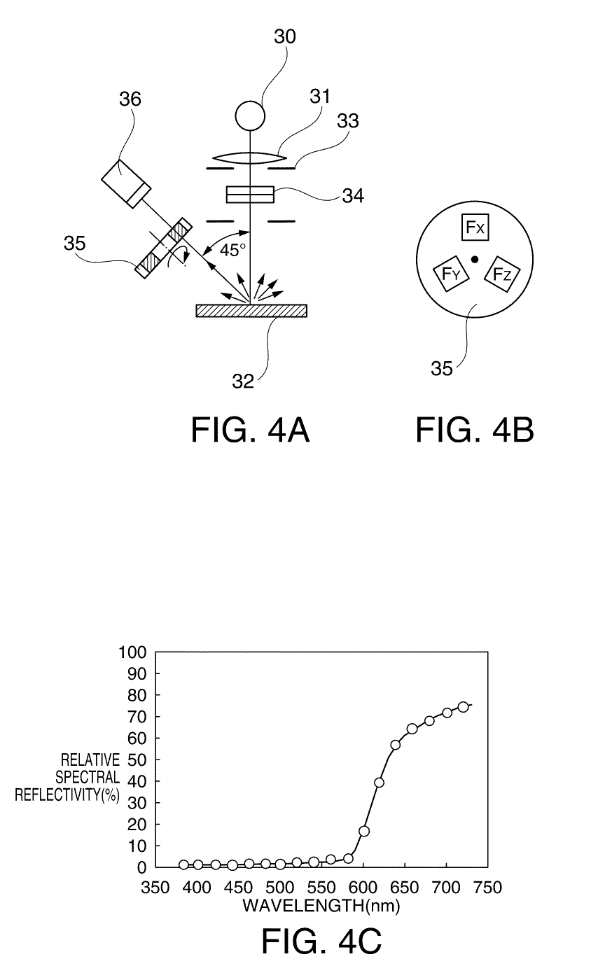

Hereinafter, the colorimetric instrument (the colorimeter) will specifically be explained as an example. FIGS. 4A through 4C are diagrams showing a configuration example of the colorimetric instrument and a measurement result of a color (red) of the sample. As shown in FIG. 4A, the colorimetric instrument has the white LED light source 30 as the light source, the lens 31, a slit 33, the spectroscopic section (spectroscopic element) 34 using the variable-gap etalon filter having the configuration and the characteristics shown in FIGS. 3A and 3B described above, a compensation filter 35, and the light receiving section (the detector) 36. It should be noted that as shown in FIG. 4B, the compensation filter 35 has filters corresponding respectively to the tristimulus values in the XYZ color system of CIE.

In the case in which the object color of the sample 32 is red (RED), the relative spectral intensity distribution corresponding to the wavelength of the light becomes the distribution illustrated by the solid line shown in FIG. 4B. The outline circles shown in FIG. 4B represent actual measurement values obtained by sampling. Specifically, the sampled actual measurement values (the sample data represented by the outline circles) correspond to the measurement result based on the signals obtained by receiving the light beams obtained by dispersing the light every 20 nm width using the variable-gap filter.

In the case of measuring the spectral reflectivity of the measurement object, there is adopted a method of measuring the reflectivity at certain wavelength intervals and then approximately estimating the continuous dispersion spectrum. Although in the case of the colorimetric measurement, for example, the method of performing the measurement at intervals of 5 nm or intervals of 10 nm is set as a standard, in the case of performing the measurement at intervals of 20 nm as in the present embodiment, the data at intervals of 10 nm is generated by interpolation to thereby calculate the chromatic coordinate.

As described above, in the colorimetric instrument shown in FIG. 4A, the white LED having advantages of having a size smaller than electric light valves, low power consumption, and long life is used as a colorimetric A light source (“A” as the standard illuminant having the incandescent color).

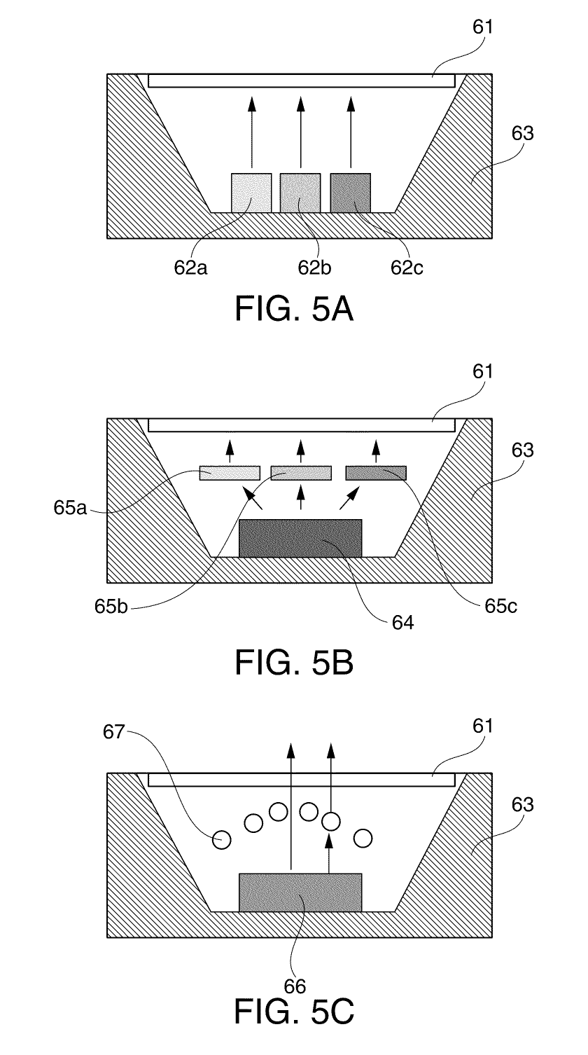

Here, with reference to FIGS. 5A through 5C, a configuration example of the white LED will be explained. FIGS. 5A through 5C are cross-sectional views of devices showing configuration examples of the white LED. In the example shown in FIG. 5A, a package is constituted with a base 63 and a transparent plate 61, and a red LED 62a, a green LED 62b, and a blue LED 62c are arranged in parallel to each other inside the package. In this example, the white light can be obtained by combining the red, green, and blue (the light's three primary colors) light beams.

Further, in the example shown in FIG. 5B, the emitted light from a near ultraviolet LED or a violet LED is applied to each of a red fluorescent material 65a, a green fluorescent material 65b, and a blue fluorescent material 65c to make the fluorescent materials emit light beams of the respective colors, thus the white light can be obtained.

Further, in the example shown in FIG. 5C, a blue LED 66 makes a yellow fluorescent material 67 emit light.

The white light can be obtained by the combination of the blue light emitted from the blue LED 66 and the yellow light (complimentary colored light) emitted by the yellow fluorescent material. The configuration example shown in FIG. 5C provides the highest luminous efficiency. Although either of the configurations can be adopted as the light source of the present embodiment, the configuration shown in FIG. 5C is preferably adopted taking the property of low power consumption and the property of high output. Hereinafter, the case in which the white LED having the configuration shown in FIG. 5C is used as the white LED will be explained as an example.

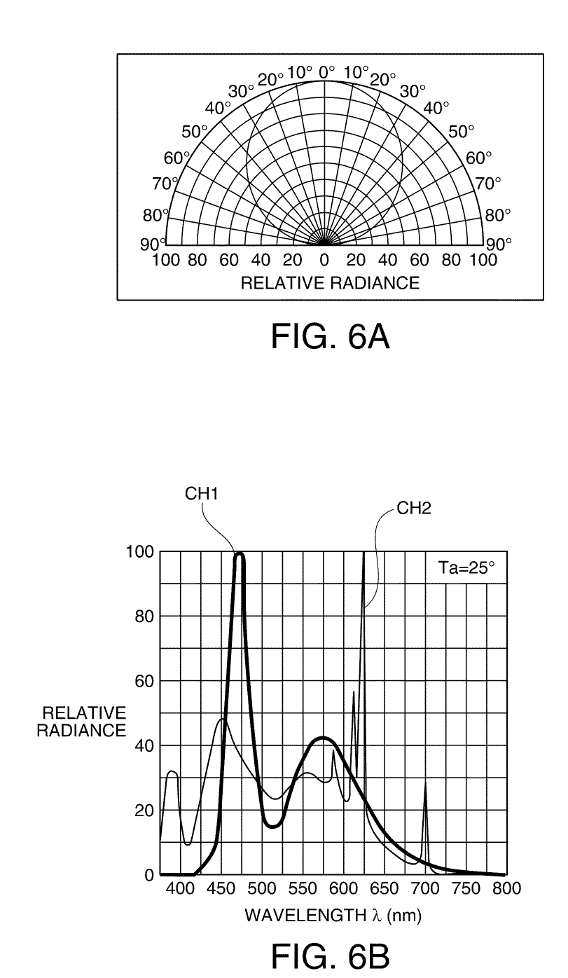

FIGS. 6A and 6B are diagrams showing a characteristic example of the white LED. FIG. 6A shows an example of the directional characteristics of the white LED, and FIG. 6B shows an example of the relative radiance (relative radiant intensity) characteristics of the white LED at 25° C. As shown in FIG. 6B, there are two types of white LED, one having the spectral intensity distribution represented by the characteristic curve CH1 (the heavy solid line), and the other having the spectral intensity distribution represented by the characteristic curve CH2 (the thin solid line). In the present embodiment, the LED having the characteristics of the characteristic curve CH1 with fewer unnecessary peaks is used.

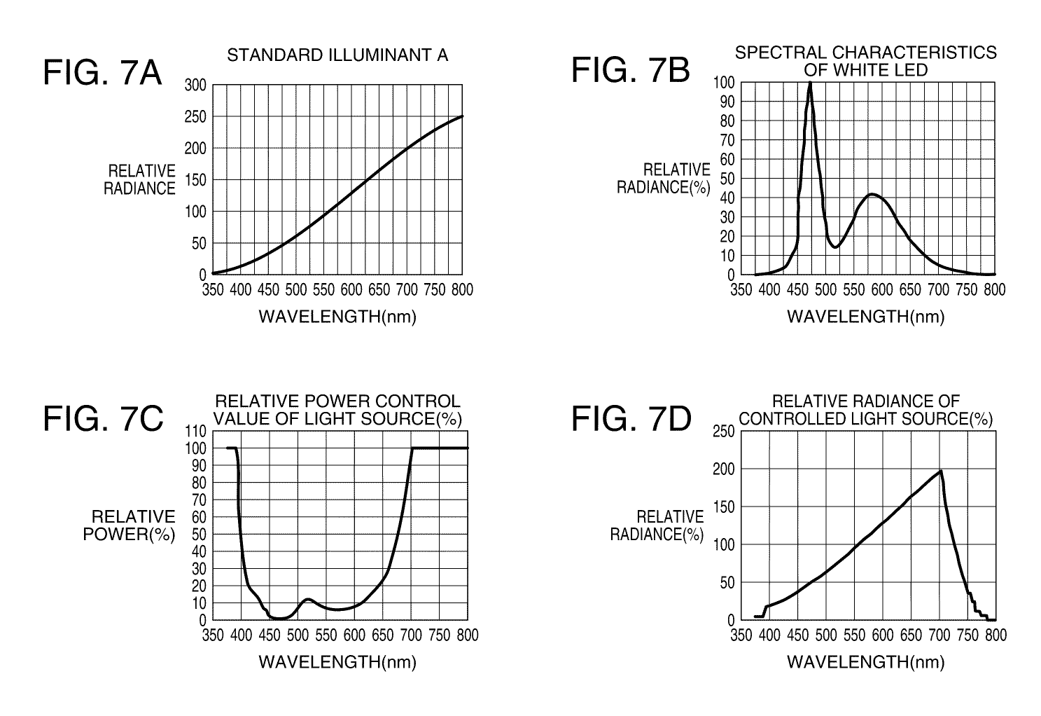

FIGS. 7A through 7D are diagrams for explaining an example of power control of a light source for using the white LED as a standard A light source (a standard illuminant A). As shown in FIG. 7A, the relative radiant intensity of the standard illuminant A shows the characteristics of roughly continuously rising in the wavelength band of 350 nm through 800 nm. On the other hand, the relative radiance characteristics of the white LED (the LED having the configuration of creating the white light using the blue LED and the yellow fluorescent material) shown in FIG. 7B is different from the radiance characteristics of the standard illuminant A, and in particular shows a sharp peak in a range of 400 nm through 500 nm. Therefore, the error is apt to be caused at the wavelength around the peak in the measurement process.

It should be noted that in the case of obtaining the spectral reflectivity of the sample 32, a predetermined correction calculation processing is performed (by the correction calculation section 43 shown in FIG. 2) on a reception output signal obtained by receiving the reflected light from the sample 32 with the photodiode PD. For example, taking the radiant characteristics of the light source 30, the reception sensitivity of the light receiving section 50, the spectral characteristics of the measurement optical system such as the lens 31, and so on into comprehensive consideration, the correction calculation process is performed so as to cancel out (compensate) the variation in signal intensity between the wavelengths due to the spectral characteristics.

Here, the dispersion spectrum of the red color shown in FIG. 4C described above is referred to. As described above, the outline dots represent the measurement points (the observational points) at intervals of 20 nm. When canceling out the spectral characteristics of the light source 30 by the correction calculation, if the discontinuous sharp peak exists in the light source itself as shown in FIG. 7B, a significant error might be caused in the spectral reflectivity.

Therefore, in the present embodiment, a power control section 12 (see FIG. 1) included in the light source drive section 10 controls the power to be applied to the light source 30 so that the variation in the discontinuous peak of the spectral radiance of the light source 30 is reduced. Specifically, the power control section 12 changes the spectral radiance characteristics of the light source having the discontinuous peak to the characteristics with the peak reduced. If the radiance distribution of the light source 30 shows the discontinuous peak, when, for example, the actual emission wavelength is slightly shifted from the ideal emission wavelength, the radiance varies dramatically to thereby cause the measurement error. If the peak is reduced, it becomes difficult to cause a significant measurement error. Therefore, the error in the colorimetric measurement and the error in the spectroscopic analysis can be reduced.

Further, in the case of calculating the chromatic coordinate in the XYZ color system in order for specifying the color of the sample, the spectral distribution is measured, and then the tristimulus values are obtained based on the spectral distribution of the illumination light and the color-matching function of the standard observer. It should be noted that the color-matching functions set by CIE assuming several limited light sources are only available. Therefore, in the case of using the white LED, the chromatic coordinate cannot be calculated unless some arithmetic processing is performed, and therefore, the arithmetic processing becomes complicated.

Therefore, in the present embodiment, the power (relative power (%) corresponding to the wavelength) applied to the light source 30 is intentionally varied between the wavelengths in accordance with the relative spectral intensity characteristics (FIG. 7B) as shown in FIG. 7C. Thus, the relative spectral intensity characteristics (FIG. 7C) of the target light source (the standard illuminant A here) are created artificially. As a result, the characteristics shown in FIG. 7D can be obtained as the relative radiant intensity characteristics of the white LED. The characteristics shown in FIG. 7D have a feature of monotonically increasing at a gradient similar to the spectral characteristics of the standard illuminant A in a wavelength band of 400 nm through 700 nm. Therefore, the white LED can be regarded as a pseudo standard light source A (the standard illuminant A) in the wavelength band.

It should be noted that although the characteristics shown in FIG. 7D are different in the wavelength band equal to or longer than about 800 nm from the relative spectral intensity characteristics of the standard illuminant A shown in FIG. 7A, in the case of the colorimetric measurement, if the characteristics in the visible range (approximately 380 nm through 750 nm) approximate to each other, no particular problem arises. It should be noted that the power control section 12, for example, performs the power control of the light source shown in FIG. 7C based on the emission intensity data 24 as described above with reference to FIG. 1.

As described above, according to the present embodiment, in the colorimetric instrument, the power control section 12 controls the power to be applied to the light source 30 so that the spectral radiance distribution of the light source 30 approximates to the relative spectral intensity distribution of the standard light source defined by the standard related to the measurement of the object color.

Thus, it becomes possible to use a variety of light sources (e.g., the white LED) as a pseudo standard light source. In other words, it is possible to use, for example, the white LED light source (the solid-state light emitting element light source) as the light source of the colorimetric instrument, and to adjust the spectral radiance characteristics of the light source so as to approximate to (including “conform with”) the relative spectral intensity characteristics of the standard light source (e.g., the standard illuminant or the auxiliary illuminant) defined by CIE, JIS, or the like. Therefore, it is possible to realize reduction of power consumption and improvement of product life of the light source without degrading the accuracy of the colorimetric measurement.

### Second Embodiment

In the present embodiment, in the spectroscopic analyzer, the power control section 12 controls the power to be applied to the light source 30 so as to reduce the difference in radiance between the wavelengths of the light source 30 in the measurement wavelength band.

Thus, the difference (variation) in emission intensity between the wavelengths of the light source of the spectroscopic analyzer can be reduced. Therefore, the measurement accuracy of the spectroscopic analyzer can be improved.

Hereinafter, the present embodiment will specifically be explained using an example of measuring the reflectance spectrum (the reflectivity at the characteristic wavelengths) of chlorophyll present in a plant leaf to thereby figure out the health condition and the growing condition of the plant.

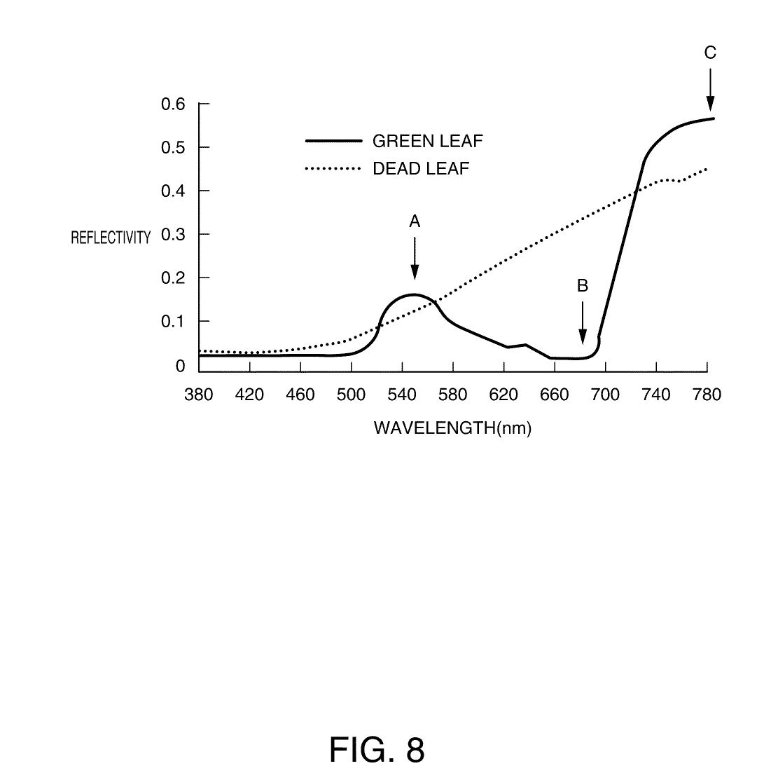

FIG. 8 is a diagram showing examples of reflectance spectra of a healthy leaf and an unhealthy leaf, respectively. In the drawing, the characteristics of the healthy leaf (a green leaf) are illustrated with a solid line, while the characteristics of the unhealthy leaf (here a dead leaf) are illustrated with a dotted line. The wavelength of around 550 nm (the vicinity of the point A) is known as a wavelength at which the reflectivity varies in accordance with the content of chlorophyll a performing photosynthesis, and the healthy leaf has higher reflectivity than the unhealthy leaf. Further, the wavelength of around 680 nm (the vicinity of the point B) corresponds to the peak wavelength in the rate of absorption of chlorophyll a, and it is understood that the reflectivity of the healthy leaf has a local minimum while the reflectivity of the unhealthy leaf fails to decrease. Further, the wavelength of around 780 nm (the vicinity of the point C) is the uppermost wavelength in the visible light range, and the healthy leaf has higher reflectivity than the unhealthy leaf.

It is required to irradiate the measurement object with the light in order for measuring the reflectance spectrum as described above similarly to the case of the colorimetric measurement. However, if the incandescent lamp such as a tungsten lamp is used as the light source, it is difficult to obtain sufficient light intensity in the shorter wavelength region. Further, since the white LED has the relative spectral intensity characteristics shown in FIG. 7B, and it is difficult to obtain the sufficient light intensity in the longer wavelength region of around 800 nm, and a sharp peak exists in a range of 400 nm through 500 nm, if the white LED is used therefor, the measurement accuracy is degraded in the vicinity of the peak wavelength. As described above, if the radiant intensity (the radiance) of the light varies between the wavelengths, it results that the measurement accuracy varies between the wavelengths.

Therefore, in order for reducing the variation in the measurement accuracy due to the wavelength, it is preferable to control the power supplied to the light source 30 in accordance with the wavelength to thereby correct the radiance (emission intensity) characteristics of the light source 30, thereby controlling the light source 30 so that the radiant intensity becomes as constant as possible in the wavelength band to be used.

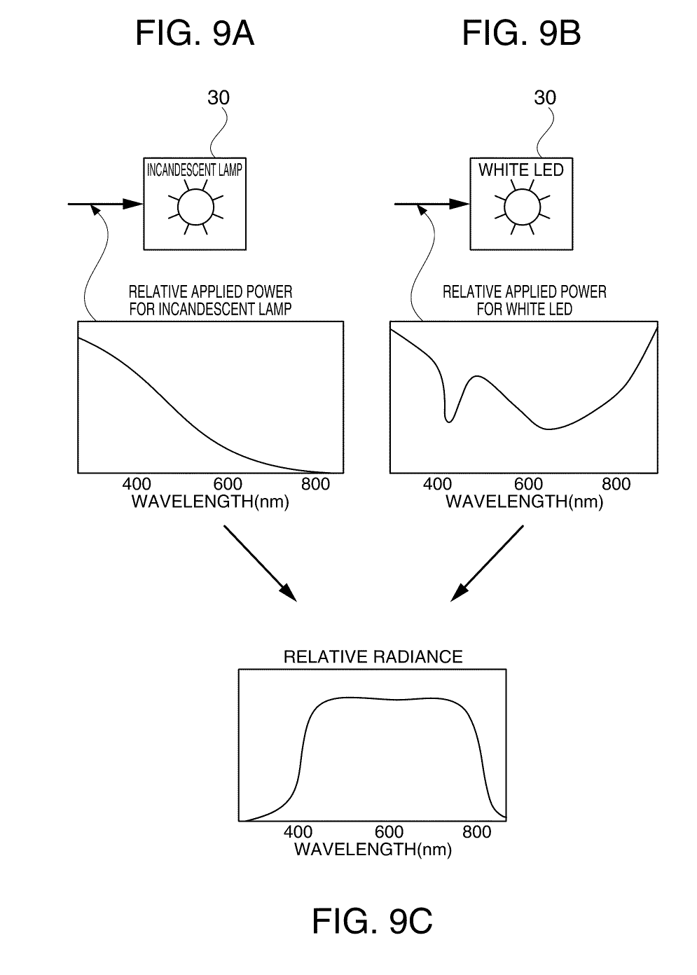

FIGS. 9A through 9C are diagrams showing an example of power control for setting the spectral radiance of the light source to approximately constant in a predetermined wavelength range. FIG. 9A shows an example of using the incandescent lamp such as a tungsten lamp as the light source. FIG. 9B shows an example of using the LED (the white LED) as the light source.

In the case of using the incandescent lamp such as a tungsten lamp as the light source 30, the power control section 12 (see FIG. 1) provides the light source 30 with the relative applied power (having reverse characteristics to the spectral radiance characteristics of the light source) shown in FIG. 9A. Further, in the case of using the white LED as the light source 30, the power control section 12 (see FIG. 1) provides the light source 30 with the relative applied power (having reverse characteristics to the spectral radiance characteristics of the light source) shown in FIG. 9B. According to such power control, the relative radiance characteristics shown in FIG. 9C can be created.

Specifically, in the relative spectral intensity distribution shown in FIG. 9C, the radiance is kept roughly constant in the wavelength band of 400 nm through 800 nm, and the variation in the emission intensity between the wavelengths is sufficiently suppressed.

Therefore, in the wavelength band of 400 nm through 800 nm, the same level of measurement accuracy can be assured at any wavelength.

As described above, in the spectroscopic analyzer according to the present embodiment, the power control section 12 controls the power to be applied to the light source 30 so as to reduce the difference in radiance between the wavelengths of the light source 30 in the measurement wavelength band. Thus, the difference (variation) in emission intensity between the wavelengths of the light source of the spectroscopic analyzer can be reduced. Therefore, the measurement accuracy of the spectroscopic analyzer can be improved.

### Third Embodiment

In the present embodiment, the power to be supplied to the light source is varied in accordance with the wavelength so as to compensate not only the variation in the radiance of the light source but also the spectral sensitivity characteristics of the light receiving element. Further, it is also possible to compensate the spectral characteristics of the measurement optical system. Thus, the measurement accuracy can further be homogenized between the wavelengths.

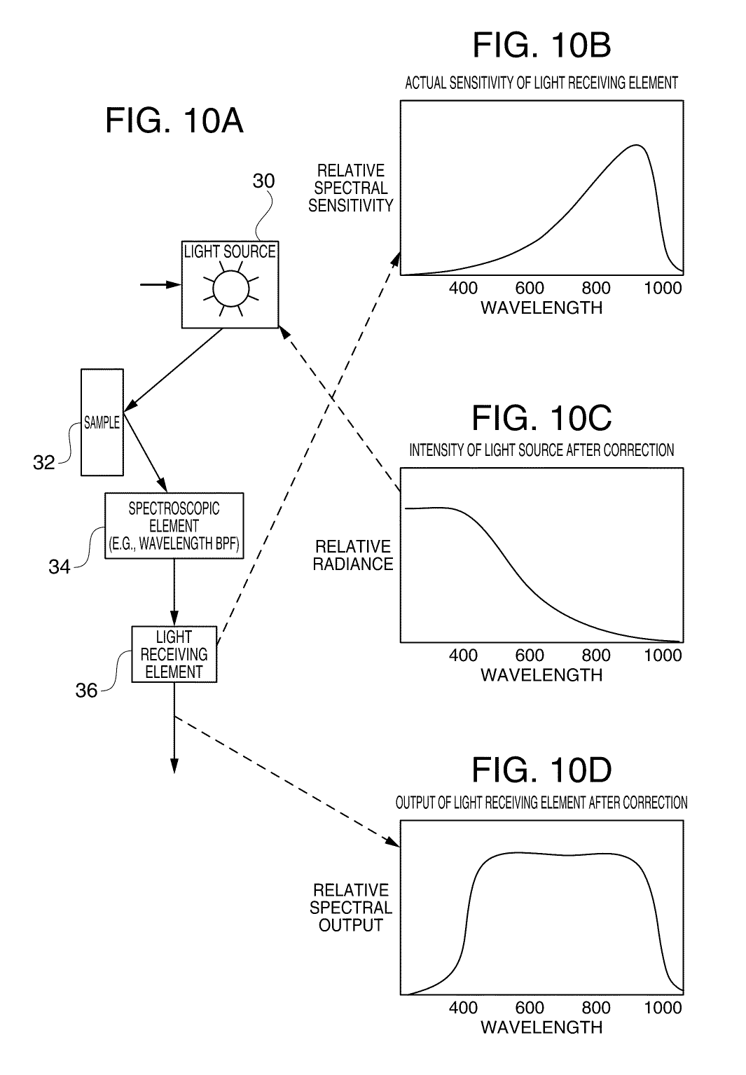

FIGS. 10A through 10D are diagrams for explaining an example of controlling the radiance characteristics of the light source taking the spectral characteristics of the light receiving section (detector) into consideration. FIG. 10A shows a principal configuration for measuring the spectral reflectivity of the sample 32. FIG. 10B shows an example of the spectral sensitivity characteristics of a CCD sensor as the light receiving section 50 (the light receiving element 36). FIG. 10C shows the spectral intensity (spectral radiance) characteristics of the light source 30 after the correction. The spectral intensity (spectral radiance) characteristics have the reverse characteristics to the spectral sensitivity characteristics of the CCD sensor. Thus, the intensity variation of the light receiving output due to the spectral sensitivity characteristics of the CCD sensor is compensated. Therefore, as a result, such spectral sensitivity characteristics of the light receiving element (the CCD sensor) as shown in FIG. 10D can be obtained.

As described above, the power control section 12 controls the power to be supplied to the light source 30 so as to reduce the difference in radiance between the wavelengths of the light source 30 and to reduce the difference in light receiving sensitivity between the wavelengths of the light receiving section 50. Thus, such a relative spectral output of the light receiving element as shown in FIG. 10C is created, and then the spectral reflectivity of the sample 12 is measured. Therefore, further homogenization of the measurement accuracy (i.e., improvement in the measurement accuracy due to the reduction of the variation in signal intensity between the wavelengths) can be achieved.

Further, it is also possible for the power control section 12 to control the power to be supplied to the light source 30 so as to reduce the variation in the intensity of the spectral output of the light receiving section 50 between the wavelengths in the measurement wavelength band due to the spectral characteristics obtained by synthesizing the radiance characteristics of the light source 30, the spectral characteristics of the measurement optical system 40 in each of the wavelengths, and the spectral sensitivity characteristics of the light receiving section 50 (the light receiving element 36).

In this case, it is possible to reduce the variation (the variation in the intensity between the wavelengths) of the light receiving section 50 (the light receiving element 36) due to the spectral characteristics obtained by synthesizing the radiance characteristics of the light source 30, the spectral characteristics of the measurement optical system 40 in each of the wavelengths, and the spectral sensitivity characteristics of the light receiving section 50.

For example, it is possible to prevent the variation in the intensity of the output of the light receiving section (the detector such as a photodiode) between the wavelengths caused by, for example, the spectral characteristics of the measurement optical system such as illumination, an optical filter, or a lens, and the spectral sensitivity of the light receiving section from varying in accordance with the wavelength (i.e., to realize flat intensity distribution characteristics with respect to the wavelength). Therefore, it is possible to prevent the measurement accuracy of the spectroscopic analyzer from varying depending on the wavelength, and thus the measurement accuracy of the spectroscopic analyzer is further improved.

Such power control of the light source is effective for preventing the degradation of the measurement accuracy particularly in the case of using the variable-gap etalon filter as the spectroscopic element. That is, if the variable-gap etalon filter is used as the spectroscopic element, although it is possible to obtain a simple, small-sized, and low-price spectroscopic section, the spectral accuracy is inevitably degraded compared to expensive spectroscopic elements. Although it is also possible that the measurement accuracy is further degraded depending on the radiance characteristics of the light source, according to the spectrometric instrument according to any one of the embodiments described above, since the degradation of the measurement accuracy due to the spectral radiance characteristics of the light source 30 is sufficiently reduced, even if the simple filter such as a variable-gap etalon filter is used, a sufficiently workable spectrometric instrument can be realized.

As is explained hereinabove, according to at least one of the embodiments of the invention, in the colorimetric instrument, while using, for example, the LED, the spectral characteristics of the light source can be conformed to the characteristics of the standard light source such as the standard illuminant or the auxiliary illuminant. Therefore, reduction of power consumption of the spectrometric instrument and enhancement of the product life of the light source can be achieved. Further, in the spectrometric instrument, it is also possible to prevent the spectral characteristics of the light passing through all of the constituents of the measurement system such as the illumination, the filter, the lens, and the light receiving element (detector) from varying between the wavelengths. In other words, the variation in the measurement accuracy between the wavelengths can be reduced.

The invention can be applied to, for example, a colorimetric instrument, a spectroscopic analyzer, a spectral image camera (a hyper-spectral camera), and in particular, preferably to a small-sized light-weight portable spectrometric instrument.

Although some embodiments are hereinabove explained, it should easily be understood by those skilled in the art that various modifications not substantially departing from the novel matters and the effects of the invention are possible.

Therefore, such modified examples should be included in the scope of the invention. For example, a term described at least once with a different term having a broader sense or the same meaning in the specification or the accompanying drawings can be replaced with the different term in any part of the specification or the accompanying drawings.

The entire disclosure of Japanese Patent Application No. 2010-126653, filed Jun. 2, 2010 is expressly incorporated by reference herein.

What is claimed is:

1. A spectrometric instrument comprising:
a light source;
a light source drive section including a power control section adapted to control drive power of the light source;
a measurement optical system including a spectroscopic section adapted to disperse light into wavelengths;
a light receiving section adapted to receive one of a reflected light beam and a transmitted light beam from a sample as a measurement object passing through the measurement optical system, and converting the light beam received into an electrical signal; and
a measurement section adapted to measure a light receiving intensity corresponding to each of the wavelengths of the light beam based on the electrical signal obtained from the light receiving section,
wherein the power control section varies the power to be applied to the light source between the wavelengths in accordance with at least one of spectral characteristics of the light source, spectral characteristics of the measurement optical system, and light receiving sensitivity characteristics of the light receiving section.

2. The spectrometric instrument according to claim 1, wherein
the spectrometric instrument is a colorimetric instrument adapted to measure a color of the sample,
the light source has spectral radiance characteristics having a discontinuous peak in a part of a wavelength band, and
the power control section controls the power to be applied to the light source so that a variation in the spectral radiance of the light source at the discontinuous peak is reduced.

3. The spectrometric instrument according to claim 1, wherein
the spectrometric instrument is a colorimetric instrument adapted to measure a color of the sample, and
the power control section controls the power to be applied to the light source so that a spectral radiance distribution of the light source approximates to a relative spectral intensity distribution of a standard light source defined by a standard related to measurement of an object color.

4. The spectrometric instrument according to claim 1, wherein
the spectrometric instrument is a spectroscopic analyzer adapted to analyze the sample, and
the power control section controls the power to be applied to the light source so as to reduce a difference in radiance of the light source between the wavelengths in a measurement wavelength band.

5. The spectrometric instrument according to claim 4, wherein
the power control section controls the power to be applied to the light source so as to reduce a difference in radiance of the light source between the wavelengths, and to reduce a difference in light receiving sensitivity of the light receiving section between the wavelengths.

6. The spectrometric instrument according to claim 1, wherein
the power control section controls the power to be applied to the light source so as to reduce a variation in the spectral output of the light receiving section between the wavelengths in the measurement wavelength band due to spectral characteristics obtained by synthesizing radiance characteristics of the light source, spectral characteristics of the measurement optical system in each of the wavelengths, and spectral sensitivity characteristics of the light receiving section.

7. The spectrometric instrument according to claim 1, wherein
the light source is one of
an incandescent lamp,
a fluorescent lamp,
a discharge tube, and
a solid-state light emitting element.

8. The spectrometric instrument according to claim 1, wherein
the spectroscopic section is one of
an etalon filter,
a variable wavelength filter, and
a diffraction grating.
